(19) United States
(12) Patent Application Publication
(10) Pub. No.: US 2025/0381889 A1
(43) Pub. Date: Dec. 18, 2025

(54) Seat Control Apparatus and Method Thereof

(71) Applicants: Hyundai Motor Company, Seoul (KR); Kia Corporation, Seoul (KR)

(72) Inventors: Kug Hun Han, Hwaseong-Si (KR); Ji Su Kim, Hwaseong-Si (KR)

(21) Appl. No.: 18/931,801

(22) Filed: Oct. 30, 2024

(30) Foreign Application Priority Data
Jun. 14, 2024 (KR) 10-2024-0077735

(51) Int. Cl. B60N 2/00; B60N 2/56; B60N 2/90

(52) U.S. Cl. CPC B60N 2/0027; B60N 2/56; B60N 2/995

(57) ABSTRACT

Disclosed is a seat control apparatus which includes a sensor, an actuator, memory, and a controller. The seat control apparatus may determine, based on a predetermined event, a seat corresponding to the predetermined event. The seat may include a leg rest. The seat control apparatus may determine, using the sensor, at least one of: state information of the seat, which is movable by the actuator, or user information of a user who is sitting on the seat; and activating, based on at least one of the state information or the user information, a heating element for the leg rest.

### CROSS-REFERENCE TO RELATED APPLICATION

This application claims the benefit of priority to Korean Patent Application No. 10-2024-0077735, filed in the Korean Intellectual Property Office on Jun. 14, 2024, the entire contents of which are incorporated herein by reference.

### TECHNICAL FIELD

The present disclosure relates to a seat control apparatus and a method thereof, and more particularly, adaptively activating a heating element for a seat.

### BACKGROUND

As vehicle technologies advance, various components of a vehicle may be operatively connected with each other. Particularly, disparate components of a seat control apparatus may interact with each other and work in concert to increase comfort convenience of a user.

For example, a host vehicle may include a seat capable of performing movements (e.g., a slide movement) backward and forward in a fully automatic way in a longitudinal direction. The seat may also include a partial area (e.g., a leg rest) that is capable of swiveling upward and downward. Such a seat may provide a heating element (e.g., wire) at one or more portions of the seat, and the heating element can be activated, for example, based on an event such as receiving an input (e.g., a switch input) from a user.

### SUMMARY

The present disclosure has been made to solve the above-mentioned problems occurring in some implementations while advantages achieved by those implementations are maintained intact.

An aspect of the present disclosure provides a seat control apparatus for identifying state information of a seat by a driving device and user information of a user who is sitting on the seat using a sensor device, if receiving a specified input related to a heating wire function from the user, and determining whether to operate the heating wire function for a leg rest based on at least some of the identified pieces of information.

Another aspect of the present disclosure provides a seat control apparatus for adaptively determining whether to operate a heating wire function for a leg rest based on state information of a seat, which includes at least one of position information of the leg rest, pressure to the leg rest, or whether there is an external object on the seat, or any combination thereof, and user information including at least one of body information of a user, a share of the user for a backrest of the seat, a separation distance between the leg rest and a calf of the user, or a head position of the user, or any combination thereof.

Another aspect of the present disclosure provides a seat control apparatus for considering a user setting state (e.g., a user setting mode (USIM)), a magnitude of pressure to a leg rest, body information of a user, a position (or angle) range including the leg rest, and the like in an overall manner to provide a heating wire function for the leg rest in a proper situation.

Another aspect of the present disclosure provides a seat control apparatus for failing to provide a heating wire function, if there is a child seat on a cushion of a seat or there is an external object (e.g., a pillow) on a leg rest to prevent unnecessary power consumption and providing the heating wire function matched with needs of the user.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a seat control apparatus may include: a sensor; an actuator; memory storing at least one instruction; and a controller operatively coupled to the sensor, the actuator, and the memory. The at least one instruction may be configured to, when executed by the controller, cause the seat control apparatus to: determine, based on a predetermined event, a seat corresponding to the predetermined event. The seat may include a leg rest. The at least one instruction may be configured to, when executed by the controller, cause the seat control apparatus to: determine, using the sensor, at least one of: state information of the seat, which is movable by the actuator, or user information of a user who is sitting on the seat; and activating, based on at least one of the state information or the user information, a heating element for the leg rest.

The seat may further include a backrest. The state information may indicate at least one of: a position of the leg rest, pressure to the leg rest, or an external object placed on the seat. The user information may indicate at least one of: body information of the user, a portion of the backrest used by the user, a distance between the leg rest and a leg of the user, or a head position of the user.

The at least one instruction may be configured to, when executed by the controller, cause the seat control apparatus to determine at least one of the state information or the user information by: determining at least one of the state information or the user information, further based on: the actuator moving the seat, and a user setting, associated with the heating element, indicating whether to, while the actuator is moving the seat, activate the heating element.

The seat control apparatus may further include: an input device associated with the heating element. The predetermined event may include receiving, via the input device, a user input for requesting to activate the heating element.

The at least one instruction may be configured to, when executed by the controller, further cause the seat control apparatus to: determine, based on the state information, an amount of pressure being applied to the leg rest; and based on the amount of pressure being less than a threshold value, leave the heating element deactivated.

The seat may further include a head rest. The at least one instruction may be configured to, when executed by the controller, further cause the seat control apparatus to: determine, based on the user information, a first position of a head of the user relative to the head rest; and, based on the first position of the head being lower than a position of the head rest and based on an angle between the leg rest and a reference line being less than a first threshold angle, leave the heating element deactivated.

The seat may further include a head rest. The at least one instruction may be configured to, when executed by the controller, further cause the seat control apparatus to: determine, based on the user information, a first position of a head of the user relative to the head rest of the seat; and, based on the first position of the head being lower than a position of the head rest and based on an angle between the leg rest and a reference line being less than a first threshold angle, activate the heating element at a first intensity that is less than a second intensity associated with the predetermined event.

The at least one instruction may be configured to, when executed by the controller, further cause the seat control apparatus to: determine, based on the user information, a second position of the head of the user relative to the head rest of the seat; and, based on the second position of the head being greater than or equal in height to the position of the head rest and based on the angle between the leg rest and the reference line being greater than the first threshold angle and less than a second threshold angle, activate the heating element. The second threshold may be greater than the first threshold angle.

The at least one instruction may be configured to, when executed by the controller, further cause the seat control apparatus to: determine, based on the user information, a third position of the head of the user relative to the head rest of the seat; and, based on the third position of the head being greater than or equal in height to the position of the head rest and based on the angle between the leg rest and the reference line being less than a third threshold angle, leave the heating element deactivated. The third threshold angle may be less than the first threshold angle.

The at least one instruction may be configured to, when executed by the controller, further cause the seat control apparatus to: determine, based on the user information, a third position of the head of the user relative to the head rest of the seat; and, based on the third position of the head being greater than or equal in height to the position of the head rest and based on the angle between the leg rest and the reference line being less than a third threshold angle, activate the heating element at a first intensity that is less than a second intensity associated with the predetermined event. The third threshold angle may be less than the first threshold angle.

The at least one instruction may be configured to, when executed by the controller, further cause the seat control apparatus to: determine, based on the user information, a fourth position of the head of the user relative to the head rest of the seat; and, based on the fourth position of the head being greater than or equal in height to the position of the head rest and based on the angle between the leg rest and the reference line being greater than the third threshold angle and less than the second threshold angle, activate the heating element.

The at least one instruction may be configured to, when executed by the controller, further cause the seat control apparatus to: provide, based on the state information indicating that a child seat is attached to the seat or that an external object is placed on the leg rest, the user with guide information associated with the heating element.

The at least one instruction may be configured to, when executed by the controller, further cause the seat control apparatus to: based on the state information indicating that a child seat is attached to the seat or that an external object is placed on the leg rest, leave the heating element deactivated.

The at least one instruction may be configured to, when executed by the controller, further cause the seat control apparatus to: determine, based on the user information: a distance between the leg rest and a leg of the user, and a height of the user; and activate the heating element, based on at least one of: the height being greater than a first height threshold value, and the distance being less than a first distance threshold value, the height being between the first height threshold value and a second height threshold value, and the distance being less than a second distance threshold value that is less than the first distance threshold value, or the height being less than the second height threshold value, and the distance being less than a third distance threshold value that is less than the second distance threshold value.

The at least one instruction may be configured to, when executed by the controller, further cause the seat control apparatus to: after activating the heating element, deactivating, based on a position of the leg rest being changed, the heating element.

According to one or more example embodiments of the present disclosure, a seat control method performed by an apparatus of a vehicle may include: determining, by a controller and based on a predetermined event, a seat corresponding to the predetermined event. The seat may include a leg rest. The seat control method may include determining, by the controller and using a sensor, at least one of: state information of the seat, or user information of a user who is sitting on the seat; and activating, based on at least one of the state information or the user information, a heating element for the leg rest.

The seat may further include a backrest. The state information may indicate at least one of: a position of the leg rest, pressure to the leg rest, or an external object placed on the seat. The user information may indicate at least one of: body information of the user, a portion of the backrest used by the user, a distance between the leg rest and a leg of the user, or a head position of the user.

Determining at least one of the state information or the user information may include: determining at least one of the state information or the user information, further based on:

the seat being moved by an actuator, and a user setting, associated with the heating element, indicating whether to, while the actuator is moving the seat, activate the heating element.

The predetermined event may include receiving a user input for requesting to activate the heating element.

The seat control method may further include: determining, by the controller and based on the state information, an amount of pressure being applied to the leg rest; and, based on the amount of pressure being less than a threshold value, leaving the heating element deactivated.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of a seat control apparatus according to an embodiment of the present disclosure;

FIG. 2 is a block diagram illustrating components of a seat control apparatus according to an embodiment of the present disclosure;

FIG. 3 is a conceptual diagram illustrating components included in a seat according to an embodiment of the present disclosure;

FIG. 4A is a graph illustrating an operation range of a heating function according to a magnitude of pressure according to an embodiment of the present disclosure;

FIG. 4B is a chart illustrating an operation range of a heating function according to an angle of a leg rest according to embodiment of the present disclosure;

FIG. 4C is a chart illustrating an operation range of a heating function according to a separation distance between a leg rest and a user according to embodiment of the present disclosure;

FIG. 5 is a conceptual diagram illustrating an operation range of a heating function according to a position interval of a leg rest according to embodiment of the present disclosure;

FIG. 6 is a flowchart of a seat control method according to an embodiment of the present disclosure;

FIG. 7 is a flowchart of a seat control method according to an embodiment of the present disclosure; and

FIG. 8 illustrates a computing system related to a seat control apparatus or a seat control method according to an embodiment of the present disclosure.

With regard to description of drawings, the same or similar denotations may be used for the same or similar components.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing the components of the embodiment of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

A seat control apparatus may include a heating function (e.g., a heating element) in one or more areas (e.g., a cushion and a backrest) which a part of the body (e.g., a back and/or a thigh) of the user comes into contact in the user's sitting position. A heating function may variously be referred to as a heating wire function, a heating element, a seat warmer, a heated seat, or a heated seat cushion.

However, there is a need to adaptively provide the heating function to other areas according to the needs of the user. For example, if the user adjusts the position of the seat to a sleep mode (e.g., fully or partially reclined position) to more comfortably position himself or herself in the seat, the calves of the user may come into contact with the leg rest portion of the seat. At this time, there is a need to adaptively activate the heating element that corresponds to the leg rest. Some implementations of a car seat may not be able to take into account the position of the seat, the sitting position of the user, and so forth when activating or deactivating portions of the heating element.

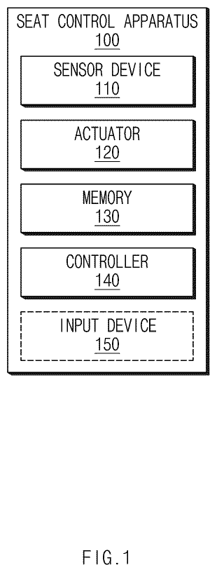

Hereinafter, embodiments of the present disclosure will be described in detail with reference to FIGS. 1 to 8.

FIG. 1 is a block diagram illustrating components of a seat control apparatus 100 according to an embodiment of the present disclosure.

According to an embodiment, the seat control apparatus 100 may include at least one of a sensor device 110 (also referred to as a sensor), an actuator 120 (also referred to as a driving device), a memory 130, a controller 140, or an input device 150, or any combination thereof. The components of the seat control apparatus 100, which are shown in FIG. 1, are illustrative, and embodiments of the present disclosure are not limited thereto. For example, the seat control apparatus 100 may further include components (e.g., at least one of an interface, a communication device, or a notification device, or any combination thereof) which are not shown in FIG. 1.

According to an embodiment, the sensor device 110 may include at least one sensor and/or switch for obtaining (or identifying) seat information n about a and/or pieces of information about a user in the host vehicle.

For example, the sensor device 110 may include a camera (or an image recognition device). As an example, the controller 140 may identify user information about the user in the host vehicle using the sensor device 110. The user information may include at least one of, for example, body information of the user, a portion (e.g., a percentage) of the backseat of the seat that is used (e.g., occupied) by the user, a separation distance between a leg rest and a leg (e.g., a calf) of the user, or a head position of the user, or any combination thereof.

As an example, the body information of the user may include at least one of a height (e.g., a sitting height, a standing height, etc.) of the user who is sitting on the seat to operate (e.g., activate) a heating function, a weight of the user, a sitting posture of the user, or a gaze direction of the user, or any combination thereof.

As an example, the portion of the backrest used by the user may include a ratio of an area with which the body (e.g., the back) of the user comes into contact to a backrest area of the seat.

As an example, the separation distance between the leg rest and the leg (e.g., calf) of the user may include the shortest distance among separation distances between one point of the leg rest and one point of the leg (e.g., calf) of the user.

As an example, the head position of the user may include a position of a head at which the head of the user is on the basis of (e.g., relative to) a head rest of the seat. For example, the controller 140 may determine whether there is the head of the user at a position lower than the position of the head rest or at a position which is the same as or higher than the position of the head rest, based on the user information obtained by means of the sensor device 110.

For example, the sensor device 110 may identify state information (or position information) of the seat based on states of components (e.g., at least one of a backrest, a head rest, a leg rest, an arm rest, or a sliding device, or any combination thereof) included in the seat. The state information of the seat may include at least one of, for example, position information of the leg rest, pressure to the leg rest, or whether there is an external object on the seat, or any combination thereof.

The leg rest may be a movable leg rest. The leg rest may be capable of, for example, moving (e.g., swinging, rotating, or swiveling) up and down along a rotational axle. As an example, the position information of the leg rest may include an angle between a specified reference line and the leg rest. In other words, the position information of the leg rest may include information (or angle information) about a state in which the leg rest moves (or rotates) based on a leg rest control device.

As an example, the pressure to the leg rest may include a magnitude of pressure applied to the leg rest due to a body (e.g., a calf) of the user, the external object, or the like.

As an example, whether there is the external object on the seat may include, for example, information about whether there is the external object (e.g., a child seat) on a cushion of the seat (or a sitting surface on which the user sits) and/or whether there is the external object (or a pillow) on the leg rest.

According to an embodiment, the actuator 120 may be configured to adjust a position of the seat. The actuator 120 may consist of two or more actuators (e.g., motors, servos, etc.).

For example, the actuator 120 may include at least one driver (e.g., at least one motor) for adjusting at least one of a reclining angle of the seat, a slide position of the seat, a head rest angle of the seat, a leg rest angle of the seat, or a swivel angle of the seat, or any combination thereof. The actuator 120 may consist of two or more actuators (e.g., motors, servos, etc.).

For example, the controller 140 may control the state of the seat to a target state corresponding to a specified input using the actuator 120. As an example, the target state may be a state set by the user.

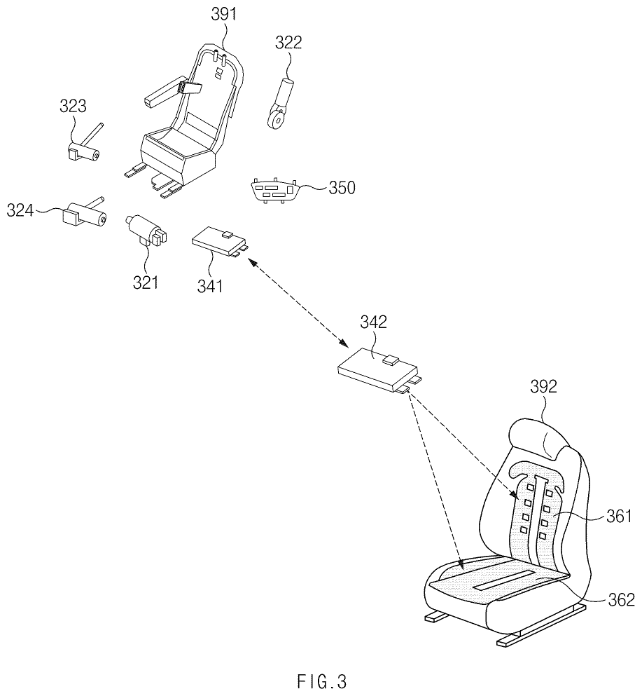

For example, an additional description of the actuator 120 will be replaced with a description of FIG. 3, which will be described.

According to an embodiment, the memory 130 may store a command or data. For example, the memory 130 may store one or more instructions, when executed by the controller 140, causing the seat control apparatus 100 to perform various operations.

For example, the memory 130 and the controller 140 may be implemented as one chipset (e.g., a logic chip, a processor, a central processing unit (CPU), an application-specific integrated circuit (ASIC), etc.). The controller 140 may include at least one of a communication processor or a modem.

For example, the memory 130 may store various pieces of information about the user. The memory 130 may store, for example, body information (e.g., a weight, a height, an upper body length, a lower body length, or a face) of a specific user. The controller 140 may identify whether a passenger who rides in the seat is the specific user based on the body information of the user, which is stored in the memory 130.

According to an embodiment, the controller 140 may be operatively connected with (e.g., coupled to) at least one of the sensor device 110, the actuator 120, or the memory 130, or any combination thereof. For example, the controller 140 may control an operation of at least one of the sensor device 110, the actuator 120, or the memory 130, or any combination thereof.

For example, if a specified event about the heating function occurs, the controller 140 may identify a seat corresponding to the specified event.

As an example, the controller 140 may be configured to determine that the specified event occurs, if a user input for requesting to operate (e.g., activate) the heating function is received via the input device 150. The input device 150 may be present on at least one area of the host vehicle, which includes at least one of, for example, one area of the seat, a center fascia, or one area of a steering wheel, or any combination thereof. As an example, the controller 140 may receive a specified input based on various types of input devices (e.g., a switch, a touch button, and a voice acquisition device) included in the sensor device 110.

As an example, the specified event may include a control signal for requesting to turn on/off the heating function in at least one area (e.g., a backrest, a sitting surface, or a leg rest, or any combination thereof) of a specific seat.

For example, if identifying the seat corresponding to the specified event, the controller 140 may identify state information of the seat by the actuator 120 and/or the user information of the user who is sitting on the seat, using the sensor device 110.

As an example, the controller 140 may check a setting state about whether to operate (e.g., activate) the heating function (e.g., heating element), if the leg rest is moving by means of the actuator 120, based on the user setting information about the heating function.

As an example, if checking that the heating function is set to be operable even if the leg rest is moving, based on the setting state, the controller 140 may identify the state information and/or the user information using the sensor device 110.

As an example, if checking that the heating function is set to be inoperable even if the leg rest is moving, based on the setting state, the controller 140 may ignore the specified event and may not activate the heating function (e.g., leave the heating function deactivated) or deactivate the heating function.

For example, the controller 140 may determine whether to operate (e.g., activate) the heating function for the leg rest included in the seat, using the state information of the seat and/or the user information.

For example, the controller 140 may identify pressure to the leg rest based on the state information of the seat. In other words, the controller 140 may determine, based on the state information of the seat, an amount of pressure being applied to the leg rest. As an example, if the pressure is smaller than a specified value, the controller 140 may not operate the heating function (e.g., leave the heating function deactivated) for the leg rest. As an example, if the pressure is greater than the specified value (e.g., 4.5 kgf), the controller 140 may operate (e.g., activate) the heating function for the leg rest. As an example, if the pressure is greater than the specified value, the controller 140 may operate (e.g., activate) the heating function, only if it is determined that at least some of conditions which will be described below are met.

For example, the controller 140 may identify a correlation between the head rest of the seat and the head position of the user based on the user information. The controller 140 may determine, for example, whether to provide the heating function for the leg rest, intensity at which the heating function is provided, or the like, based on the correlation.

As an example, if it is identified that there is the head of the user at the position lower than the position of the head rest, the controller 140 may determine that the user corresponds to a child. At this time, for example, if the angle between the leg rest and the specified reference line is smaller than a first angle (e.g., 17 degrees), the controller 140 may not operate the heating function (e.g., leave the heating function deactivated). At this time, for another example, if the angle between the leg rest and the specified reference line is smaller than the first angle, the controller 140 may operate (e.g., activate) the heating function for the leg rest based on intensity smaller than the operation intensity corresponding to the specified event. In other words, if it is determined that the angle of the leg rest is included in the above-mentioned range in the situation in which the user is determined as the child, the controller 140 may not provide the heating function for the leg rest or may provide the heating function at relatively small intensity, thus preventing unnecessary power consumption. For example, if it is identified that there is the head of the user at the position lower than the position of the head rest and if the angle between the leg rest and the specified reference line is greater than the first angle and is smaller than a second angle (e.g., 90 degrees) greater than the first angle, the controller 140 may operate (e.g., activate) the heating function for the leg rest. In other words, if it is determined that the angle of the leg rest is included in the above-mentioned angle in the situation in which the user is determined as the child, the controller 140 may determine that the heating function via the leg rest will be normally provided to the user.

As an example, if it is identified that there is the head of the user at the position which is the same as or higher than the position of the head rest, the controller 140 may determine that the user corresponds to an adult. At this time, for example, if the angle between the leg rest and the specified reference line is smaller than a third angle smaller than the first angle, the controller 140 may not operate the heating function for the leg rest (e.g., leave the heating function deactivated). At this time, for another example, if the angle between the leg rest and the specified reference line is smaller than the third angle, the controller 140 may operate (e.g., activate) the heating function for the leg rest based on intensity smaller than the operation intensity corresponding to the specified event. In other words, if it is determined that the angle of the leg rest is included in the above-mentioned range in the situation in which the user is determined as the adult, the controller 140 may not provide the heating function (e.g., leave the heating function deactivated) for the leg rest or may provide (e.g., activate) the heating function at relatively small intensity, thus preventing unnecessary power consumption. For example, if it is identified that there is the head of the user at the position which is the same as or higher than the position of the head rest and if the angle between the leg rest and the specified reference line is greater than the third angle and is smaller than the second angle, the controller 140 may operate (e.g., activate) the heating function for the leg rest. In other words, if it is determined that the angle of the leg rest is included in the above-mentioned angle in the situation in which the user is determined as the adult, the controller 140 may determine that the heating wire function via the leg rest will be normally provided to the user.

As an example, if it is identified that there is an external object (e.g., a pillow) on the leg rest and if the angle between the leg rest and the specified reference line is less than or equal to a fourth angle (e.g., 45 degrees), the controller 140 may not provide the heating function for the leg rest.

The specified reference line may be defined as, for example, a line corresponding to the leg rest in a situation in which there is the leg rest at a containment position. The specified reference line may be defined as, for example, a line perpendicular to the ground.

The controller 140 may determine whether the user is the adult or the child based on the correlation between the head position of the user and the head rest in the above-mentioned example, but embodiments of the present disclosure are not limited thereto.

As an example, the controller 140 may determine whether the user is an adult or a child using the sensor device 110 (e.g., a camera). For example, if it is identified that the height (e.g., a standing height or a stature) of the user is greater than a first value (e.g., 165 cm), based on the user information, the controller 140 may determine that the user is a relatively large adult. As an example, if it is identified that the height of the user is between the first value and a second value (e.g., 100 cm), the controller 140 may determine that the user is a relatively small adult. As an example, if it is identified that the height of the user is less than the second value, the controller 140 may determine that the user is a child.

As an example, the controller 140 may determine whether the user is an adult or a child based on the portion of the backrest used by the user. For example, if the ratio of the body (e.g., the back) of the user, which is coming into contact with the backrest, to the entire area of the backrest is greater than a specified ratio (e.g., 70%), the controller 140 may determine that the user is an adult. For example, if the ratio of the body (e.g., the back) of the user, which is coming into contact with the backrest, to the entire area of the backrest is less than or equal to the specified ratio (e.g., 70%), the controller 140 may determine that the user is a child.

For example, the controller 140 may determine whether there is another object except for the user on the seat based on the state information of the seat.

As an example, if identifying that there is a child seat on the seat (or the sitting surface) (e.g., a child car seat is attached to the seat) or there is the external object (e.g., the pillow) on the leg rest, based on the state information of the seat, the controller 140 may provide the user with guide information about the heating function. The guide information may include, for example, a notification that thermal conduction is not performed although the heating function operates (e.g., activate) in the current state. The controller 140 may not operate the heating function (e.g., leave the heating function deactivated) for now, in such a situation.

For example, the controller 140 may identify a separation distance between the leg rest and the calf of the user and a height of the user, based on the user information and/or the state information of the seat.

As an example, if the height is greater than a first value (e.g., 160 cm) and the separation distance is less than a first distance (e.g., 20 cm), the controller 140 may operate (e.g., activate) the heating function. This case may be defined as a case in which it is determined that the user corresponds to a relatively large adult.

As an example, if the height is between the first value and a second value (e.g., 100 cm) and the separation distance is less than a second distance (e.g., 10 cm), the controller 140 may operate (e.g., activate) the heating function. This case may be defined as a case in which it is determined that the user corresponds to a relatively small adult.

As an example, if the height is less than the second value and the separation distance is less than a third distance (e.g., 5 cm), the controller 140 may operate (e.g., activate) the heating function. This case may be defined as a case in which it is determined that the user corresponds to a child.

For example, after determining to operate (e.g., activate) the heating function based on that at least some of the above-mentioned conditions are met and activating the heating function for the leg rest, if identifying that the leg rest is moving (or if position change control of the leg rest is identified) by means of the actuator 120, the controller 140 may stop (e.g., deactivate) the heating function for the leg rest. The controller 140 may not stop the heating function (e.g., leave the heating function activated) in the process of moving the leg rest, depending on the user setting state.

For example, the controller 140 may independently control a heating element included in an area (e.g., a backrest and/or a sitting surface) different from the heating element included in the leg rest among heating elements provided in the seat to provide the heating function. In other words, although the controller 140 does not operate the (e.g., activate) heating function for the leg rest based on the above-mentioned example, it may provide the heating function for the different area using the heating element included in the different area.

According to an embodiment, the input device 150 may include at least one input device for receiving a user input to some of the components of the host vehicle.

For example, the input device 150 may include at least one of at least one switch, a touch screen, or a voice acquisition device, or any combination thereof.

For example, the input device 150 may be disposed on one area of at least one seat, a center fascia, a rear surface of a passenger seat, and/or one surface of a trunk.

For example, the input device 150 may receive a position control input to at least some of a plurality of seats in the host vehicle from the user.

As an example, if receiving a pressure input to the switch or a touch input to the touch screen, and/or a voice input to the voice acquisition device from the user via the input device 150, the seat control apparatus 100 may perform position control and/or heating function control for at least a portion (e.g., a leg rest, a backrest, a head rest, or the like) of the seat corresponding to the input.

As an example, the seat control apparatus 100 may receive a user input about position control and/or heating function control by means of a specific seat from the user via the input device 150. The user input may include, for example, a user input for the user to request to control the position of the seat in a predefined state or a specific state corresponding to the user input received via the input device 150. The user input may include, for example, a user input for requesting to turn on/off the heating function via all or some of heating wires included in the seat.

The components of the seat control apparatus 100, which are shown in FIG. 1, are illustrative, and embodiments of the present disclosure are not limited thereto. For example, the seat control apparatus 100 may further include at least one of a communication device or an interface, or any combination thereof.

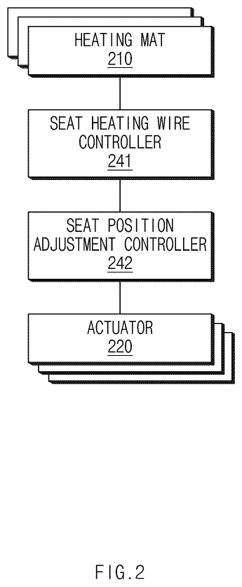

FIG. 2 is a block diagram illustrating components of a seat control apparatus according to an embodiment of the present disclosure.

According to an embodiment, a seat control apparatus (e.g., a seat control apparatus 100 of FIG. 1) may include at least one of a heating mat 210, a seat heating wire controller 241, a seat position adjustment controller 242, or an actuator 220 (e.g., the actuator 120 of FIG. 1), or any combination thereof.

For example, the seat heating wire controller 241 and the seat position adjustment controller 242 are illustrated as independently divided components, but may be integrated and implemented into one device (e.g., a controller 140 of FIG. 1).

For example, the seat heating wire controller 241 may operate (e.g., activate) the heating mat 210 included in a seat, thus providing a user with a heating function via the seat. The heating mat 210 may be provided in, for example, each of seats in a host vehicle. The heating mat 210 may be provided in, for example, each of at least one area including a backrest, a sitting surface, and a leg rest of the seat.

For example, the seat position adjustment controller 242 may perform a position control function for each of the seats in the host vehicle using the actuator 220. The actuator 220 may include, for example, at least one motor. The actuator 220 may include at least one of, for example, a leg rest motor for adjusting an angle (or rotation) of a leg rest, a height motor for adjusting a height of the seat, a slide motor for adjusting a slide position of the seat, or a reclining motor for adjusting a backrest angle of the seat, or any combination thereof.

The components of the seat control apparatus, which are shown in FIG. 2, are illustrative, and the seat control apparatus may further include another configuration which is not shown in FIG. 2.

FIG. 3 is a conceptual diagram illustrating components included in a seat according to an embodiment of the present disclosure.

According to an embodiment, a seat control apparatus (e.g., a seat control apparatus 100 of FIG. 1) may control a position control function and/or a heating function for a seat using at least some of the components shown in FIG. 3.

For example, the seat may include a seat frame 391 and a seat appearance 392.

For example, the seat control apparatus may include at least one of at least one motor (e.g., a slide motor 321, a reclining motor 322, a tilting motor (or a height motor) 323, or a leg rest motor 324) for position control of the seat, an input device 350, a first control unit 341 (or a seat position adjustment controller 242 of FIG. 2), a second control unit 342 (or a seat heating wire controller 241 of FIG. 2), a first heating wire device 361, or a second heating wire device 362, or any combination thereof. The first control unit 341 and the second control unit 342 are illustrated as independently divided components, but may be integrated and implemented into one device (e.g., a controller 140 of FIG. 1).

For example, the seat control apparatus may control at least one of an angle (or an amount of rotation) of a leg rest, a height of the seat, a slide position of the seat, or a backrest angle of the seat, or any combination thereof using the at least one motor. As an example, the seat control apparatus may control a position (or a state) of the seat by means of the amount of control corresponding to an input to at least a part of the input device 350, based on the input.

For example, the first control unit 341 and the second control unit 342 may mutually transmit and receive state information of the seat, activation information of a heating function, and the like.

For example, the second control unit 342 may provide the heating function via an area corresponding to each of the first heating wire device 361 included in the backrest of the seat and the second heating wire device 362 included in a sitting surface, using the first heating wire device 361 and/or the second heating wire device 362.

For example, the heating wire devices are illustrated as two in FIG. 3, but embodiments of the present disclosure are not limited thereto. As an example, the seat control apparatus may further include a third heating wire device (not shown) provided in the leg rest.

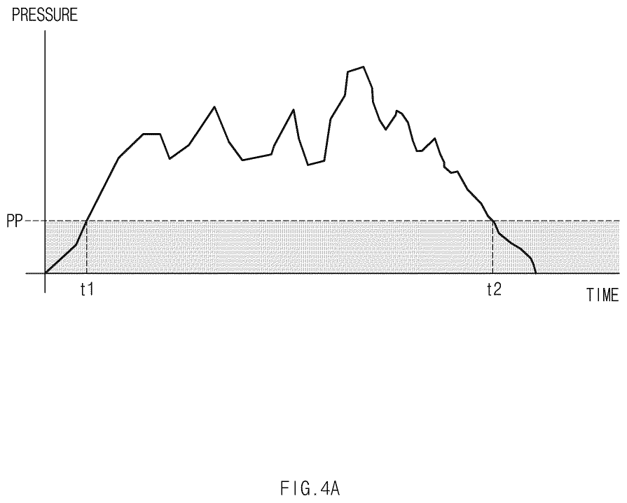

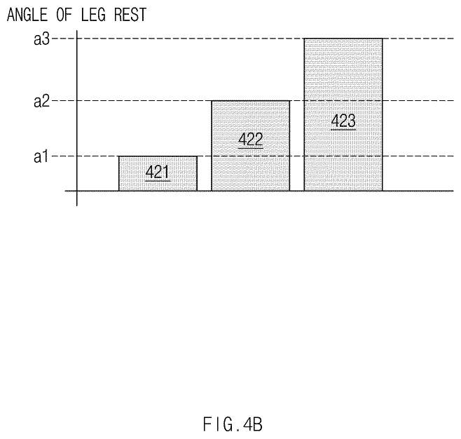

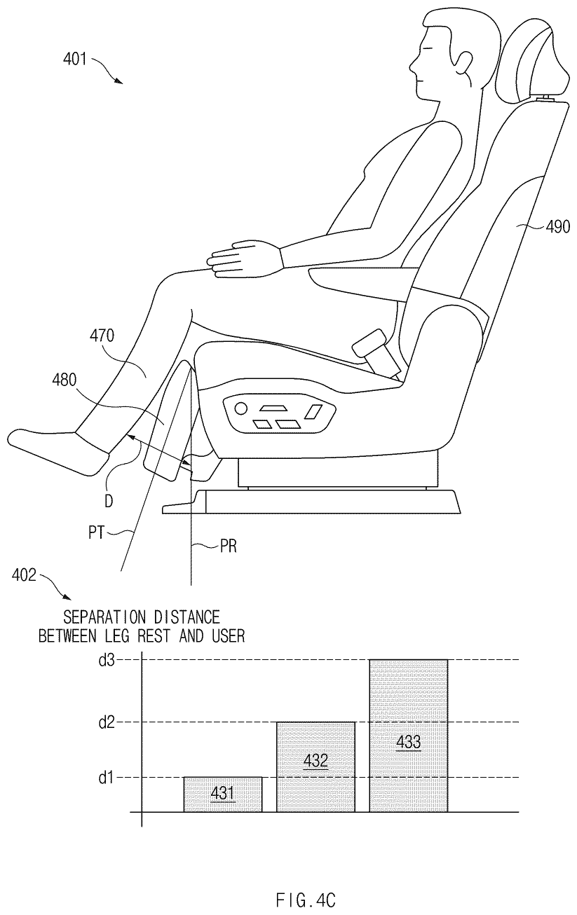

FIG. 4A is a graph illustrating an operation range of a heating function according to a magnitude of pressure according to an embodiment of the present disclosure.

According to an embodiment, a seat control apparatus (e.g., a seat control apparatus 100 of FIG. 1) may identify a magnitude of pressure to a leg rest to determine whether a condition for providing a heating function via the leg rest is met.

For example, only if the magnitude of pressure to the leg rest is greater than a specified value PP (e.g., 4 kgf), the seat control apparatus may activate the heating function via the leg rest.

For example, because the magnitude of pressure to the leg rest is less than or equal to the specified value PP, during a time from 0 to t1, although a specified event occurs, the seat control apparatus may not provide the heating function via the leg rest.

For example, because the magnitude of pressure to the leg rest is greater than the specified value PP, during a time from t1 to t2, if the specified event occurs, the seat control apparatus may provide the heating function via the leg rest. At this time, if at least some of the other conditions described above in the description of FIG. 1 (e.g., conditions using body information of a user), the seat control apparatus may provide the heating function via the leg rest.

For example, because the magnitude of pressure to the leg rest is less than or equal to the specified value PP, during a time after t2, although the specified event occurs, the seat control apparatus may not provide the heating function via the leg rest.

FIG. 4B is a chart illustrating an operation range of a heating function according to an angle of a leg rest according to embodiment of the present disclosure.

According to an embodiment, a seat control apparatus (e.g., a seat control apparatus 100 of FIG. 1) may use an angle of a leg rest and body information of a user to determine whether a condition for providing a heating function via the leg rest is met.

For example, if the height of the user is greater than or equal to a specified value (e.g., 100 cm), the seat control apparatus may determine that the user is an adult. In this case, referring to reference numeral 421, only if an angle between the leg rest and a reference line is greater than a1 (e.g., 5 degrees), the seat control apparatus may operate (e.g., activate) the heating function for the leg rest.

For example, if the height of the user is less than the specified value (e.g., 100 cm), the seat control apparatus may determine that the user is a child. In this case, referring to reference numeral 422, only if the angle between the leg rest and the reference line is greater than a2 (e.g., 17 degrees), the seat control apparatus may operate (e.g., activate) the heating function for the leg rest.

For example, the seat control apparatus may determine whether to activate the heating function depending on whether there is an external object on a seat, regardless of the height of the user. As an example, referring to reference numeral 423, if it is determined that there is the external object on the leg rest of the seat and only if the angle between the leg rest and the reference line is greater than a3 (e.g., 45 degrees), the seat control apparatus may operate (e.g., activate) the heating function for the leg rest.

It is described that the seat control apparatus determines whether the user is the adult or the child depending on the height of the user, but this is illustrative. An embodiment of the present disclosure is not limited thereto. For example, the seat control apparatus may determine a user type using a user body share for a backrest and/or a correlation between a head position of the user and a head rest position.

FIG. 4C is a chart illustrating an operation range of a heating function according to a separation distance between a leg rest and a user according to embodiment of the present disclosure.

According to an embodiment, a seat control apparatus (e.g., a seat control apparatus 100 of FIG. 1) may use a height of a user and a separation distance D between a leg rest 480 and at least a part (e.g., a calf 470) of the body of the user to determine whether a condition for providing a heating function via the leg rest 480 is met. The seat control apparatus may identify, for example, a correlation between the calf 470 and the leg rest 480 and body information (e.g., a height) of the user who sits on a seat 490 based on user information about the user using a sensor device.

Referring to reference numeral 401, according to an embodiment, the seat control apparatus may identify the separation distance D between the calf 470 of the user and the leg rest 480. The separation distance D may be, for example, a distance from a predefined reference line PR corresponding to the leg rest 480 assuming that there is the leg rest 480 at a containment position to the calf 470. For another example, the separation distance D may be a distance from a real-time reference line PT corresponding to the identified leg rest 480 after the real-time position of the leg rest 480 according to FIG. 4C is identified to the calf 470.

Referring to reference numeral 402, according to an embodiment, the seat control apparatus may determine whether to operate (e.g., activate) a heating function for the leg rest 480, based on a magnitude of the separation distance D and/or the height of the user.

For example, if the height of the user is greater than a first value (e.g., 160 cm), the seat control apparatus may determine that the user is a relatively large adult. In this case, referring to reference numeral 433, only if the separation distance between the leg rest 480 and the calf 470 of the user is smaller than d3 (e.g., 20 cm), the seat control apparatus may operate (e.g., activate) the heating function for the leg rest 480.

For example, if the height of the user is between the first value and a second value (e.g., 100 cm), the seat control apparatus may determine that the user is a relatively small adult. In this case, referring to reference numeral 432, only if the separation distance between the leg rest 480 and the calf 470 of the user is smaller than d2 (e.g., 10 cm), the seat control apparatus may operate (e.g., activate) the heating function for the leg rest 480.

For example, if the height of the user is less than the second value (e.g., 100 cm), the seat control apparatus may determine that the user is a child. In this case, referring to reference numeral 431, only if the separation distance between the leg rest 480 and the calf 470 of the user is smaller than d1 (e.g., 5 cm), the seat control apparatus may operate (e.g., activate) the heating function for the leg rest 480.

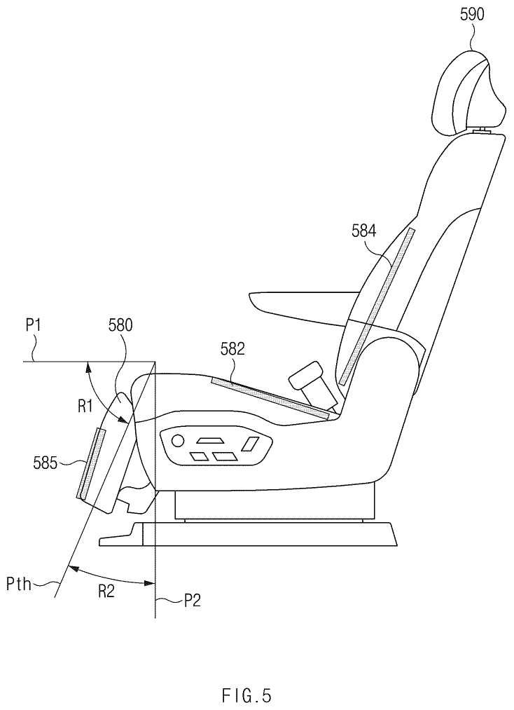

FIG. 5 is a conceptual diagram illustrating an operation range of a heating function according to a position interval of a leg rest according to embodiment of the present disclosure.

According to an embodiment, a seat control apparatus (e.g., a seat control apparatus 100 of FIG. 1) may determine whether to provide a heating function depending to an angle range of a leg rest 580.

For example, the seat control apparatus may independently determine whether to provide the heating function via each of various configurations (e.g., a backrest, a sitting surface, and the leg rest 580) included in a seat 590.

For example, if a specified event about the heating function via the seat occurs, the seat control apparatus may independently provide the heating function via each area using at least one of a first heating wire device 585 provided in one area of the leg rest 580, a second heating wire device 582 provided in one area of a sitting surface, or a third heating wire device 584 provided in one area of a backrest, or any combination thereof.

For example, the seat control apparatus may determine whether to provide the heating function via the third heating wire device 584 based on an angle between the leg rest 580 and a specified reference line. A maximum value (or a second angle) (e.g., 90 degrees) of the angle between the leg rest 580 and the specified reference line may be defined as a case in which there is the leg rest 580 at a first position P1. A minimum value (e.g., 0 degree) of the angle between the leg rest 580 and the specified reference line may be defined as a case in which there is the leg rest 580 at a second position P2. As will be described below, the seat control apparatus may identify a threshold position Pth of the leg rest 580 according to a type of the user (e.g., an adult or a child). The threshold position Pth may be determined based on, for example, the type of the user and the angle between the leg rest 580 and the specified reference line.

As an example, the seat control apparatus may determine whether the user is an adult or a child based on user information (e.g., a correlation between a position of the head of the user and a head rest, a height of the user, or a portion of the backrest used by the user) obtained by means of a sensor device.

For example, if it is determined that the user is the child, the seat control apparatus may determine whether the angle between the leg rest 580 and the specified reference line is smaller than a first angle (e.g., 17 degrees).

As an example, if the angle between the leg rest 580 and the specified reference line is smaller than the first angle in the situation in which the user is determined as the child, the seat control apparatus may determine that the angle deviates from an operable range R1 and is included in an inoperable range R2. In this case, the seat control apparatus may not activate the third heating wire device 584 to not operate the heating function (e.g., leave the heating function deactivated) for the leg rest 580 or may operate (e.g., activate) the heating function for the leg rest 580 based on intensity smaller than operation intensity corresponding to the specified event.

As an example, if the angle between the leg rest 580 and the specified reference line is greater than the first angle (or is greater than the first angle and is smaller than a second angle) in the situation in which the user is determined as the child, the seat control apparatus may determine that the angle is included in the operable range R1. In this case, the seat control apparatus may activate the third heating wire device 584 to operate (e.g., activate) the heating function for the leg rest 580.

For example, if it is determined that the user is the adult, the seat control apparatus may determine whether the angle between the leg rest 580 and the specified reference line is smaller than a third angle (e.g., 5 degrees).

As an example, if the angle between the leg rest 580 and the specified reference line is smaller than the third angle in the situation in which the user is determined as the adult, the seat control apparatus may determine that the angle deviates from the operable range R1 and is included in the inoperable range R2. In this case, the seat control apparatus may not activate the third heating wire device 584 to not operate (e.g., activate) the heating function for the leg rest 580 or may operate (e.g., activate) the heating function for the leg rest 580 based on intensity smaller than the operation intensity corresponding to the specified event.

As an example, if the angle between the leg rest 580 and the specified reference line is greater than the third angle (or is greater than the third angle and is smaller than the second angle) in the situation in which the user is determined as the adult, the seat control apparatus may determine that the angle is included in the operable range R1. In this case, the seat control apparatus may activate the third heating wire device 584 to operate (e.g., activate) the heating function for the leg rest 580.

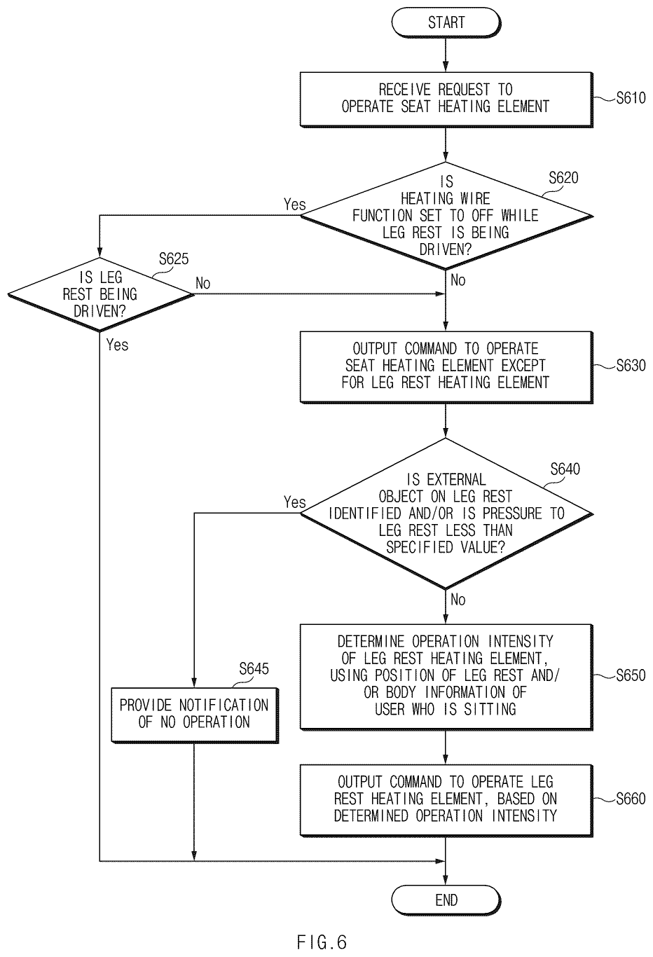

FIG. 6 is a flowchart of a seat control method according to an embodiment of the present disclosure.

According to an embodiment, a seat control apparatus (e.g., a seat control apparatus 100 of FIG. 1) may perform operations disclosed in FIG. 6. For example, at least some of components (e.g., a sensor device 110, an actuator 120, a memory 130, a controller 140, and an input device 150 of FIG. 1) included in the seat control apparatus may be configured to perform the operations of FIG. 6.

Operations in S610 to S660 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 6, may be briefly described or omitted.

According to an embodiment, in S610, the seat control apparatus may receive a request to operate (e.g., activate) a seat heating element.

For example, the seat control apparatus may receive a user input about a heating function via a seat, via an input device.

According to an embodiment, in S620, the vehicle control apparatus may identify whether the heating function is set to OFF while a leg rest is being driven.

For example, the seat control apparatus may check a setting state about whether to operate (e.g., activate) the heating function, if the leg rest is moving by means of an actuator, based on user setting information about the heating function.

For example, if the heating function is set to OFF while the leg rest is being driven, based on the user setting information (e.g., S620—Yes), the seat control apparatus may perform S625.

For example, if the heating function is not set to OFF while the leg rest is being driven, based on the user setting information (e.g., S620—No), the seat control apparatus may perform S630.

According to an embodiment, in S625, the vehicle control apparatus may identify whether the leg rest is being driven.

For example, if the leg rest is being driven (e.g., S625—Yes), the seat control apparatus may end the operation.

For example, if the leg rest is not being driven (e.g., S625—No), the seat control apparatus may perform S630.

According to an embodiment, in S630, the seat control apparatus may output a command to operate (e.g., activate) the seat heating element except for a leg rest heating element.

For example, the seat control apparatus may suspend providing a heating function via the leg rest for a while, may output a command to operate (e.g., activate) another seat heating element (e.g., a heating element included in a backrest and/or a sitting surface), and may provide the heating function via the corresponding area.

According to an embodiment, in S640, the seat control apparatus may determine whether an external object on the leg rest is identified and/or whether pressure to the leg rest is less than a specified value.

For example, if the external object on the leg rest is identified (or if the external object on a sitting surface is identified) or the pressure to the leg rest is less than the specified value (e.g., S640—Yes), the seat control apparatus may perform S645.

For example, if the external object on the leg rest is not identified and the pressure to the leg rest is greater than or equal to the specified value (e.g., S640—No), the seat control apparatus may perform S650.

According to an embodiment, in S645, the seat control apparatus may provide a notification of no operation.

For example, the seat control apparatus may provide a user with guide information about the heating function via the leg rest.

For example, the seat control apparatus may not operate (e.g., activate) the heating function via the leg rest and may provide the user with guide information including the notification of no operation based on visual and/or audible content. The guide information may include, for example, a notification that thermal conduction is impossible or the heating function is not normally provided although the heating element provided in the leg rest is activated.

According to an embodiment, in S650, the seat control apparatus may determine operation intensity of the leg rest heating element, using a position of the leg rest and/or body information of the user who is sitting.

For example, the seat control apparatus may identify a type of the user based on at least one of a height of the user, a correlation between a head position of the user and a position of a head rest, or a portion of the backrest used by the user, or any combination thereof.

For example, the seat control apparatus may determine whether to operate (e.g., activate) the heating element provided in the leg rest and/or operation intensity of the heating element provided in the leg rest, using the type of the user and position information of the leg rest.

According to an embodiment, in S660, the seat control apparatus may output a command to operate (e.g., activate) the leg rest heating element, based on the determined operation intensity.

For example, the seat control apparatus may not operate the leg rest heating element (e.g., leave the heating function deactivated), depending on whether the condition determined in S650 is met, and may output an operation command based on the determined operation intensity.

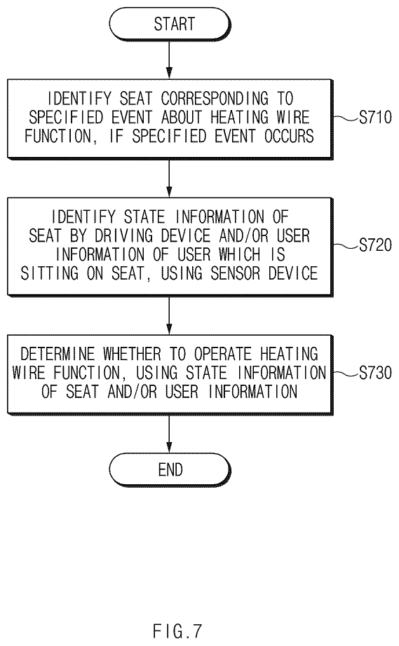

FIG. 7 is a flowchart of a seat control method according to an embodiment of the present disclosure.

According to an embodiment, a seat control apparatus (e.g., a seat control apparatus 100 of FIG. 1) may perform operations disclosed in FIG. 7. For example, at least some of components (e.g., a sensor device 110, an actuator 120, a memory 130, a controller 140, and an input device 150 of FIG. 1) included in the seat control apparatus may be configured to perform the operations of FIG. 7.

Operations in S710 to S730 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

According to an embodiment, in S710, the seat control apparatus may identify a seat corresponding to a specified event about a heating function, if the specified event occurs.

For example, if a user input for requesting to operate (e.g., activate) the heating function is received via an input device, the seat control apparatus may determine that the specified event occurs and may identify a target seat for activating the heating function.

According to an embodiment, in S720, the seat control apparatus may identify state information of the seat by an actuator and/or user information of a user who is sitting on the seat, using a sensor device.

According to an embodiment, in S730, the seat control apparatus may determine whether to operate (e.g., activate) the heating function, using the state information of the seat and/or the user information.

For example, the seat control apparatus may determine whether an operation condition for activating the heating function via a leg rest is met, using at least a portion of the state information of the seat and/or the user information. The seat control apparatus may determine, for example, whether to operate (e.g., activate) the heating function via the leg rest or may adjust operation intensity, depending on the operation condition is met. The description of whether the operation condition is met may be replaced with the description of FIG. 1, which is described above.

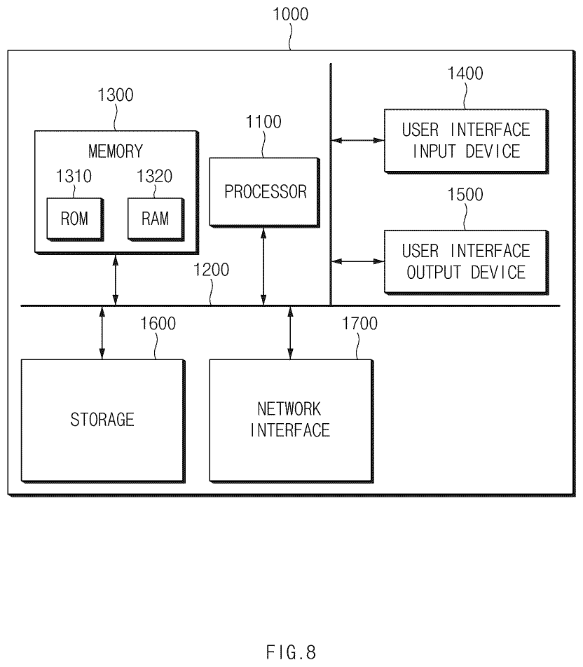

FIG. 8 illustrates a computing system about a seat control apparatus or a seat control method according to an embodiment of the present disclosure.

Referring to FIG. 8, a computing system 1000 about the seat control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the seat control apparatus and the method thereof according to an embodiment of the present disclosure.

Embodiments of the present disclosure may provide the seat control apparatus configured to identify state information of a seat by an actuator and user information of a user who is sitting on the seat using a sensor device, if receiving a specified input about a heating function from the user, and determine whether to operate (e.g., activate) the heating function for a leg rest based on at least some of the identified pieces of information.

Embodiments of the present disclosure may provide the seat control apparatus configured to adaptively determine whether to operate (e.g., activate) the heating function for the leg rest based on the state information of the seat, which includes at least one of position information of the leg rest, pressure to the leg rest, or whether there is an external object on the seat, or any combination thereof, and the user information including at least one of body information of the user, a portion of the backrest used by the user, a separation distance between the leg rest and the calf of the user, or a head position of the user, or any combination thereof.

Embodiments of the present disclosure may provide the seat control apparatus configured to consider a user setting state (e.g., a user setting mode (USIM)), a magnitude of pressure to the leg rest, body information of the user, a position (or angle) range including the leg rest, and the like in an overall manner to provide the heating function for the leg rest in a proper situation.

Embodiments of the present disclosure may provide the seat control apparatus configured to not provide the heating function, if there is a child seat on a cushion of the seat or there is an external object (e.g., a pillow) on the leg rest to prevent unnecessary power consumption and provide the heating function matched with needs of the user.

According to an aspect of the present disclosure, a seat control apparatus may include a sensor device, a driving device, a memory storing at least one instruction, and a controller operatively connected with the sensor device, the driving device, and the memory. For example, the at least one instruction may, when executed by the controller, cause the seat control apparatus to identify a seat corresponding to a specified event related to a heating wire function, if the specified event occurs, identify at least one of state information of the seat by the driving device or user information of a user who is sitting on the seat, or any combination thereof, using the sensor device, and determine whether to operate the heating wire function for a leg rest included in the seat, using the at least one of the state information or the user information, or the any combination thereof.

According to an embodiment, the state information may include at least one of position information of the leg rest, pressure to the leg rest, or whether there is an external object on the seat, or any combination thereof. The user information may include at least one of body information of the user, a share of the user for a backrest of the seat, a separation distance between the leg rest and a calf of the user, or a head position of the user, or any combination thereof.

According to an embodiment, the at least one instruction may, when executed by the controller, cause the seat control apparatus to check a setting state related to whether to operate the heating wire function, if the leg rest is moving by means of the driving device, based on user setting information related to the heating wire function, and identify the state information and the user information using the sensor device, if it is checked that the heating wire function is set to be operable if the leg rest is moving, based on the setting state.

According to an embodiment, the seat control apparatus may further include an input device related to operation of the heating wire function. For example, the at least one instruction may, when executed by the controller, cause the seat control apparatus to determine that the specified event occurs, if a user input for requesting to operate the heating wire function is received via the input device.

According to an embodiment, the at least one instruction may, when executed by the controller, cause the seat control apparatus to identify pressure to the leg rest, based on the state information, and fail to operate the heating wire function for the leg rest, if the pressure is smaller than a specified value.

According to an embodiment, the at least one instruction may, when executed by the controller, cause the seat control apparatus to identify a position of a head of the user on the basis of a head rest of the seat, based on the user information, and, if it is identified that there is the head at a position lower than a position of the head rest, fail to operate the heating wire function for the leg rest, if an angle between the leg rest and a specified reference line is smaller than a first angle.

According to an embodiment, the at least one instruction may, when executed by the controller, cause the seat control apparatus to identify a position of a head of the user on the basis of a head rest of the seat, based on the user information, and, if it is identified that there is the head at a position lower than a position of the head rest, operate the heating wire function for the leg rest based on intensity smaller than operation intensity corresponding to the specified event, if an angle between the leg rest and a specified reference line is smaller than a first angle.

According to an embodiment, the at least one instruction may, when executed by the controller, cause the seat control apparatus to, if it is identified that there is the head at a position which is the same as the position of the head rest or is higher than the position of the head rest, operate the heating wire function for the leg rest, if the angle between the leg rest and the specified reference line is greater than the first angle and is smaller than a second angle greater than the first angle.

According to an embodiment, the at least one instruction may, when executed by the controller, cause the seat control apparatus to identify the position of the head of the user on the basis of the head rest of the seat, based on the user information, and, if it is identified that there is the head at the position which is the same as the position of the head rest or is higher than the position of the head rest, fail to operate the heating wire function for the leg rest, if the angle between the leg rest and the specified reference line is smaller than a third angle smaller than the first angle.

According to an embodiment, the at least one instruction may, when executed by the controller, cause the seat control apparatus to identify the position of the head of the user on the basis of the head rest of the seat, based on the user information, and, if it is identified that there is the head at the position which is the same as the position of the head rest or is higher than the position of the head rest, operate the heating wire function for the leg rest based on intensity smaller than operation intensity corresponding to the specified event, if the angle between the leg rest and the specified reference line is smaller than a third angle smaller than the first angle.

According to an embodiment, the at least one instruction may, when executed by the controller, cause the seat control apparatus to identify the position of the head of the user on the basis of the head rest of the seat, based on the user information, and, if it is identified that there is the head at the position which is the same as the position of the head rest or is higher than the position of the head rest, operate the heating wire function for the leg rest, if the angle between the leg rest and the specified reference line is greater than the third angle and is smaller than the second angle.

According to an embodiment, the at least one instruction may, when executed by the controller, cause the seat control apparatus to provide the user with guide information related to the heating wire function, if identifying there is a child seat on the seat or there is an external object on the leg rest based on the state information of the seat.

According to an embodiment, the at least one instruction may, when executed by the controller, cause the seat control apparatus to fail to operate the heating wire function, if identifying that there is a child seat on the seat or there is an external object on the leg rest based on the state information of the seat.

According to an embodiment, the at least one instruction may, when executed by the controller, cause the seat control apparatus to identify a separation distance between the leg rest and a calf of the user and a height of the user, based on the user information, and operate the heating wire function for the leg rest, if the height is greater than a first value and the separation distance is less than a first distance, if the height is between the first value and a second value and the separation distance is less than a second distance smaller than the first distance, or if the height is less than the second value and the separation distance is less than a third distance smaller than the second distance.

According to an embodiment, the at least one instruction may, when executed by the controller, cause the seat control apparatus to stop the heating wire function for the leg rest, if position change control of the leg rest is identified by means of the driving device after determining to operate the heating wire function and activating the heating wire function for the leg rest.

According to another aspect of the present disclosure, a seat control method may include identifying, by a controller, a seat corresponding to a specified event related to a heating wire function, if the specified event occurs, identifying, by the controller, at least one of state information of the seat by a driving device or user information of a user who is sitting on the seat, or any combination thereof, using a sensor device, and determining, by the controller, whether to operate the heating wire function for a leg rest included in the seat, using the at least one of the state information or the user information, or the any combination thereof.

According to an embodiment, the state information may include at least one of position information of the leg rest, pressure to the leg rest, or whether there is an external object on the seat, or any combination thereof. The user information may include at least one of body information of the user, a share of the user for a backrest of the seat, a separation distance between the leg rest and a calf of the user, or a head position of the user, or any combination thereof.

According to an embodiment, the seat control method may further include checking, by the controller, a setting state related to whether to operate the heating wire function, if the leg rest is moving by means of the driving device, based on user setting information related to the heating wire function, and identifying, by the controller, the state information and the user information using the sensor device, if it is checked that the heating wire function is set to be operable if the leg rest is moving, based on the setting state.

According to an embodiment, the seat control method may further include determining, by the controller, that the specified event occurs, if a user input for requesting to operate the heating wire function is received via an input device.

According to an embodiment, the seat control method may further include identifying, by the controller, pressure to the leg rest, based on the state information, and failing to operate the heating wire function for the leg rest, if the pressure is smaller than a specified value.

The technical problems to be solved by the present disclosure are not limited to the aforementioned problems, and any other technical problems not mentioned herein will be clearly understood from the following description by those skilled in the art to which the present disclosure pertains.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A seat control apparatus comprising:
a sensor;
an actuator;
memory storing at least one instruction; and
a controller operatively coupled to the sensor, the actuator, and the memory,
wherein the at least one instruction is configured to, when executed by the controller, cause the seat control apparatus to:
determine, based on a predetermined event, a seat corresponding to the predetermined event, wherein the seat comprises a leg rest;
determine, using the sensor, at least one of:
state information of the seat, which is movable by the actuator, or
user information of a user who is sitting on the seat; and
activating, based on at least one of the state information or the user information, a heating element for the leg rest.

2. The seat control apparatus of claim 1, wherein the seat further comprises a backrest,
wherein the state information indicates at least one of: a position of the leg rest, pressure to the leg rest, or an external object placed on the seat, and
wherein the user information indicates at least one of: body information of the user, a portion of the backrest used by the user, a distance between the leg rest and a leg of the user, or a head position of the user.

3. The seat control apparatus of claim 1, wherein the at least one instruction is configured to, when executed by the controller, cause the seat control apparatus to determine at least one of the state information or the user information by:
determining at least one of the state information or the user information, further based on:
the actuator moving the seat, and
a user setting, associated with the heating element, indicating whether to, while the actuator is moving the seat, activate the heating element.

4. The seat control apparatus of claim 1, further comprising:
an input device associated with the heating element,
wherein the predetermined event comprises receiving, via the input device, a user input for requesting to activate the heating element.

5. The seat control apparatus of claim 1, wherein the at least one instruction is configured to, when executed by the controller, further cause the seat control apparatus to:
determine, based on the state information, an amount of pressure being applied to the leg rest; and
based on the amount of pressure being less than a threshold value, leave the heating element deactivated.

6. The seat control apparatus of claim 1, wherein the seat further comprises a head rest, and wherein the at least one instruction is configured to, when executed by the controller, further cause the seat control apparatus to:
determine, based on the user information, a first position of a head of the user relative to the head rest; and
based on the first position of the head being lower than a position of the head rest and based on an angle between the leg rest and a reference line being less than a first threshold angle, leave the heating element deactivated.

7. The seat control apparatus of claim 1, wherein the seat further comprises a head rest, and wherein the at least one instruction is configured to, when executed by the controller, further cause the seat control apparatus to:
determine, based on the user information, a first position of a head of the user relative to the head rest of the seat; and
based on the first position of the head being lower than a position of the head rest and based on an angle between the leg rest and a reference line being less than a first threshold angle, activate the heating element at a first intensity that is less than a second intensity associated with the predetermined event.

8. The seat control apparatus of claim 6, wherein the at least one instruction is configured to, when executed by the controller, further cause the seat control apparatus to:
determine, based on the user information, a second position of the head of the user relative to the head rest of the seat; and
based on the second position of the head being greater than or equal in height to the position of the head rest and based on the angle between the leg rest and the reference line being greater than the first threshold angle and less than a second threshold angle, activate the heating element, wherein the second threshold angle is greater than the first threshold angle.

9. The seat control apparatus of claim 8, wherein the at least one instruction is configured to, when executed by the controller, further cause the seat control apparatus to:
determine, based on the user information, a third position of the head of the user relative to the head rest of the seat; and
based on the third position of the head being greater than or equal in height to the position of the head rest and based on the angle between the leg rest and the reference line being less than a third threshold angle, leave the heating element deactivated, wherein the third threshold angle is less than the first threshold angle.

10. The seat control apparatus of claim 8, wherein the at least one instruction is configured to, when executed by the controller, further cause the seat control apparatus to:
determine, based on the user information, a third position of the head of the user relative to the head rest of the seat; and
based on the third position of the head being greater than or equal in height to the position of the head rest and based on the angle between the leg rest and the reference line being less than a third threshold angle, activate the heating element at a first intensity that is less than a second intensity associated with the predetermined event, and wherein the third threshold angle is less than the first threshold angle.

11. The seat control apparatus of claim 10, wherein the at least one instruction is configured to, when executed by the controller, further cause the seat control apparatus to:
determine, based on the user information, a fourth position of the head of the user relative to the head rest of the seat; and
based on the fourth position of the head being greater than or equal in height to the position of the head rest and based on the angle between the leg rest and the reference line being greater than the third threshold angle and less than the second threshold angle, activate the heating element.

12. The seat control apparatus of claim 1, wherein the at least one instruction is configured to, when executed by the controller, further cause the seat control apparatus to:
provide, based on the state information indicating that a child seat is attached to the seat or that an external object is placed on the leg rest, the user with guide information associated with the heating element.

13. The seat control apparatus of claim 1, wherein the at least one instruction is configured to, when executed by the controller, further cause the seat control apparatus to:
based on the state information indicating that a child seat is attached to the seat or that an external object is placed on the leg rest, leave the heating element deactivated.

14. The seat control apparatus of claim 1, wherein the at least one instruction is configured to, when executed by the controller, further cause the seat control apparatus to:
determine, based on the user information:
a distance between the leg rest and a leg of the user, and
a height of the user; and
activate the heating element, based on at least one of:
the height being greater than a first height threshold value, and the distance being less than a first distance threshold value,
the height being between the first height threshold value and a second height threshold value, and the distance being less than a second distance threshold value that is less than the first distance threshold value, or
the height being less than the second height threshold value, and the distance being less than a third distance threshold value that is less than the second distance threshold value.

15. The seat control apparatus of claim 1, wherein the at least one instruction is configured to, when executed by the controller, further cause the seat control apparatus to:
after activating the heating element, deactivating, based on a position of the leg rest being changed, the heating element.

16. A seat control method performed by an apparatus of a vehicle, the seat control method comprising:
determining, by a controller and based on a predetermined event, a seat corresponding to the predetermined event, wherein the seat comprises a leg rest;
determining, by the controller and using a sensor, at least one of:
state information of the seat, or
user information of a user who is sitting on the seat; and
activating, based on at least one of the state information or the user information, a heating element for the leg rest.

17. The seat control method of claim 16, wherein the seat further comprises a backrest,
wherein the state information indicates at least one of: a position of the leg rest, pressure to the leg rest, or an external object placed on the seat, and
wherein the user information indicates at least one of: body information of the user, a portion of the backrest used by the user, a distance between the leg rest and a leg of the user, or a head position of the user.

18. The seat control method of claim 16, wherein the determining of at least one of the state information or the user information comprises:
determining at least one of the state information or the user information, further based on:
the seat being moved by an actuator, and
a user setting, associated with the heating element, indicating whether to, while the actuator is moving the seat, activate the heating element.

19. The seat control method of claim 16, wherein the predetermined event comprises receiving a user input for requesting to activate the heating element.

20. The seat control method of claim 16, further comprising:
determining, by the controller and based on the state information, an amount of pressure being applied to the leg rest; and
based on the amount of pressure being less than a threshold value, leaving the heating element deactivated.
